(19) United States
(12) Patent Application Publication
(10) Pub. No.: US 2026/0195642 A1
(43) Pub. Date: Jul. 9, 2026

(54) PREDICTING USER TRAFFIC METRICS IN COMPUTER NETWORKS

(71) Applicant: Telefonaktiebolaget LM Ericsson (publ), Stockholm (SE)

(72) Inventors: Paulo Antonio MOREIRA MIJARES, Málaga (ES); José María RUIZ AVILÉS, Málaga (ES); Juan RAMIRO MORENO, Málaga (ES); Jose OUTES CARNERO, Torremolinos (ES); Adriano MENDO MATEO, Málaga (ES); Yak NG MOLINA, Málaga (ES); Rakibul Islam RONY, Málaga (ES)

(73) Assignee: Telefonaktiebolaget LM Ericsson (publ), Stockholm (SE)

(21) Appl. No.: 19/129,670

(22) PCT Filed: Apr. 27, 2023
(86) PCT No.: PCT/IB2023/054385

§ 371 Date: May 14, 2025

(30) Foreign Application Priority Data
Dec. 13, 2022 (EP) 22383207.2

(51) Int. Cl. G06N 20/00

(52) U.S. Cl. CPC G06N 20/00

(57) ABSTRACT

A computing system (600) collects input data associated with a network and generates one or more features (210) from the input data. The computing system (600) trains a plurality of metrics models (230) to predict respective metrics and predicts the respective metrics using the plurality of metrics models (230).

### RELATED APPLICATIONS

This application claims the benefit of European Patent Application EP22383207 filed 13 Dec. 2022, the entire disclosure of which is incorporated by reference herein in its entirety.

### TECHNICAL FIELD

Embodiments of the present disclosure generally relate to wireless communication networks, and more particularly relates to the use of artificial intelligence principles to predict characteristics of user traffic.

### BACKGROUND

Prediction of Radio Frequency (RF) metrics such as Reference Signal Received Power (RSRP), Reference Signal Received Quality (RSRQ), Channel Quality Indicator (CQI), Reference Signal Signal-to-Noise Ratio (RSSNR), and Physical Downlink Shared Channel (PDSCH) Signal-to-Interference Ratio (SINR) have been widely studied by the telecommunications industry. Indeed, the understanding of the radio environment has become critical for most of the activities in the radio design and optimization domain. Although it is important to understand and estimate traditional RF metrics such as these, a more accurate indicator of network performance and/or user satisfaction can, at times, be user data throughput and/or latency, as measured on the uplink (UL), the downlink (DL), or both.

User throughput and latency in a network can, at times, be a cornerstone of network strategy formulation processes and subsequent Capital Expenditure (CapEx) investment. Traditionally, DL/UL User Throughput and Latency is mainly driven by the quality of the radio channel, network capacity, and application service performance. A good radio channel tends to facilitate higher Signal-to-Noise Ratios (SNRs) and the use of higher modulation and coding schemes. In contrast, high network utilization tends to force the system to multiplex resources between different users in a more aggressive way, thereby reducing throughput and increasing service latencies.

Given the importance of predicting and estimating DL/UL user throughput and latency metrics accurately, the advent of Artificial Intelligence (AI) methodologies has permeated more deeply into the regular design and optimization activities of the network. The levels of accuracy achieved by these systems tend to be higher than has historically been achieved through classical modeling.

### SUMMARY

The present disclosure is generally directed to predicting DL/UL user throughput and latency in RF networks, particularly through AI computing techniques. Particular embodiments include an automation methodology able to predict several RF metrics (e.g., DL/UL user throughput/latency) by coordinating different machine learning models. The outputs of the system may include cell maps for RSRQ, CQI, RSSNR, PDSCH SINR, DL/UL user throughput, and latency estimations.

Embodiments of the present disclosure include a method implemented by a computing system. The method comprises collecting input data associated with a network and generating one or more features from the input data. The method further comprises training a plurality of metrics models to predict respective metrics and predicting the respective metrics using the plurality of metrics models.

In some embodiments, training the plurality of metrics models comprises training the plurality of metrics models using a plurality of independent training stages executed in parallel.

In some embodiments, the method further comprises predicting the respective metrics comprises predicting a first set of metrics using a first set of the metrics models and predicting a second set of metrics using the first set of metrics as input to a second set of the metrics models. In some such embodiments, predicting the respective metrics further comprises predicting a third set of metrics using the second set of metrics as input to a third set of the metrics models. In some such embodiments, the method further comprises the first set of metrics comprises Reference Signal Received Quality, Channel Quality Indicator, and/or Reference Signal Signal-to-Noise Ratio. Additionally or alternatively, the second set of metrics comprises Signal-to-Interference Ratio (SINR) in some embodiments. Additionally or alternatively, the third set of metrics comprises uplink user throughput, downlink user throughput, and/or latency in some embodiments.

In some embodiments, the collected input data comprises measured data obtained from a plurality of different locations spanning a geographic area. The collected input data is missing metrics from one or more of the different locations. Predicting the respective metrics using the plurality of metrics models comprises predicting the missing metrics for each of the one or more of the different locations.

Other embodiments include a computing system comprising processing circuitry and memory circuitry. The memory circuitry stores instructions executable by the processing circuitry whereby the computing system is configured. The computing system is configured to collect input data associated with a network and generate one or more features from the input data. The computing system is further configured to train a plurality of metrics models to predict respective metrics and predict the respective metrics using the plurality of metrics models.

In some embodiments, the computing system is further configured to perform any of the methods described above.

Other embodiments include a computer program comprising instructions that, when executed on processing circuitry of a computing system, cause the computing system to carry out any one of the methods described above.

Yet other embodiments include a carrier containing said computer program. The carrier is one of an electronic signal, optical signal, radio signal, or computer readable storage medium.

### BRIEF DESCRIPTION OF THE FIGURES

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a training stage 115, generally, as opposed to discussion of particular instances of training stages 115a, 115b, 115c).

FIG. 1 is a flow diagram illustrating an example procedure for predicting metrics, according to one or more embodiments of the present disclosure.

FIG. 2 is a flow diagram illustrating an example training phase for training metrics models, according to one or more embodiments of the present disclosure.

FIG. 3 is a flow diagram illustrating an example training stage for training an RSRQ model, a CQI model, and an RSSNR model, according to one or more embodiments of the present disclosure.

FIGS. 4A and 4B are flow diagrams illustrating example training stages for training a SINR model, according to one or more embodiments of the present disclosure.

FIG. 5 is a flow diagram illustrating an example training stage for training a DL throughput model, an UL throughput model, and a latency model, according to one or more embodiments of the present disclosure

FIG. 6 is a flow diagram illustrating an example method implemented by a computing system, according to one or more embodiments of the present disclosure.

FIG. 7 is a flow diagram illustrating an example prediction phase for predicting metrics, according to one or more embodiments of the present disclosure.

FIG. 8 is a block diagram schematically illustrating an example computing system, according to one or more embodiments of the present disclosure.

### DETAILED DESCRIPTION

Traditional RF metric prediction solutions tend to fall into one of two broad types. One such type includes the use of classical planning tools. These tools typically have some level of automation and centralize the prediction process for the above-mentioned metrics. However, these tools typically rely on classical methodologies and models rather than more modern AI techniques. As such, classical methods typically provided limited accuracy.

The second type of traditional RF metric prediction solution is one that uses AI for most predictions. However, such solutions often provide isolated solutions using different types of data. As such, they often lack the automation and centralization that the aforementioned classically based type provides.

As will be discussed in greater detail below, particular embodiments of the present disclosure not only provide for automation and centralization, but also leverage AI-based prediction techniques. At least some such embodiments provide prediction capabilities for latency that are notably absent from the aforementioned traditional solution approaches.

In particular, there are no latency studies of note that have been able to take advantage of all the gathered data combined and produce a single and coordinated AI based prediction for all the necessary radio environment metrics required consistently. The lack of such a study presents numerous difficulties in the field of wireless networking.

For example, although known studies into RF metrics do, at times, use local calibration due to a measurements-based approach, they traditionally lack important things (e.g., handset capability types) that directly affect achievable throughput, among other things. Additionally, the lack of automation and centralization tends to increase overall solution complexity in terms of engineering calibration, data collection, and/or IT resources, particularly in cases where parallelization is required.

Existing solutions tend to use only a static value of load, which limits the ability to forecast predictions by analyzing tendencies of a cell and the surrounding area. In contrast, embodiments of the present disclosure use real loading (or capacity) figures from one or more cells and use this information to understanding impact in time and/or spatial dimensions over multiple time spans (e.g., in the short, medium, and long term).

Although UL user throughput predictions are possible through some existing solutions, viable prediction methodologies for latency are absent. As will be discussed further below, the ability to take network configuration into account and provide a fully automated and centralized solution enables the prediction of multiple metrics together in a consistent fashion, with less effort, and having more complex derivations (e.g., Carrier Aggregation or Dual connectivity DL/UL User Throughput). Although classical planning tools may, in theory, be able to create these types of derivations, as noted above such tools rely on theoretical models having significant accuracy limitations. Moreover, such tools typically fail to consider most network parameters configuration while making predictions.

Although it is possible to create PDSCH SINR maps using classical tools, these tools rely of theoretical models. Further, such approaches do not provide any specific solution or prediction for this metric, which is particularly important in beamforming for Fifth Generation (5G) wireless communication.

Embodiments of the present disclosure recognize that certain quality metrics (e.g., CQI) are affected by system constants that can affect the estimations done by the handset. The fact that known classical tools and known metrics studies fail to take these types of constants into account when using pre-trained models in new areas or networks further affects overall accuracy. In contrast, embodiments of the present disclosure apply the configuration of the network for pre-trained models in new areas or networks not involved in the training step.

Moreover, although certain traditional solutions are measurement-based (which tends to provide good accuracy), such an approach can also be quite limiting. Such limitations are especially noticeable when working with greenfield scenarios where there are no network elements to get data from; e.g., when there is only a design plan. In contrast, particular embodiments of the present disclosure take advantage of centralized solutions and builds automatic models that learn from the whole network and extrapolate this knowledge into network elements in the plan for which there are no actual measurements.

Although maps can be used for better visualization results, embodiments of the present disclosure do not require the use of maps and the effect on accuracy models is insignificant as compared to traditional solutions that may require very accurate maps for predictions.

Further, the lack of centralization or coordination between the predictions provided by different traditional models may cause significant deviations on results. Having different and separate systems, each having their own ways of working and estimating error may significantly decrease the overall prediction accuracy, thereby deriving suboptimal decisions. In contrast, the utilization of integrated models with a common strategy may result in a more consistent and cohesive set of predictions, which elevates the accuracy of the design and optimization process.

Moreover, the absence of a tightly coordinated and integrated solution makes it more difficult to commercialize the use cases that require some level of manual orchestration as a software product.

To overcome one or more of the aforementioned difficulties with traditional solutions, a particular example embodiment of the present disclosure comprises two primary phases; namely, a training phase followed by a prediction phase. The training phase is represented by RF metrics, DL/UL user throughput, and latency models training. Real measurements from users and network performance are used as inputs to the training phase. In this regard, models that are adapted to the specific network environment under study are generated.

The prediction phase uses the models previously generated in sequence. First, cell maps for RF metrics are generated from RSRP measurements, network performance, and configuration inputs as discussed above. Then, the RF metrics are used together to generate DL/UL user throughput and latency predictions.

Thus, particular embodiments of the present disclosure automatically generate predictions of important metrics used in the radio network industry. In this regard, certain embodiments may provide a pipeline that can generate full area maps for numerous cells based on a geographically sparse set of samples and specific AI models. At least some such embodiments benefit from automation and centralization (i.e., advantages provided by classical tools) joined with modern AI techniques that have been a subject of different studies to limited respective extents. Particular solutions include certain network performance counters, configuration parameters, and handset information aimed to improving the accuracy of the overall system relative to traditional solutions. Further, particular embodiments provide new metrics predictions such as latency, the understanding of which will be critical for new services in 5G. The designed features for one or more models may be a combination of geolocated user data, network statistics coming from an Operations Support System (OSS), and configuration info. The use of such input improves the expected accuracy of the predictions over traditional approaches.

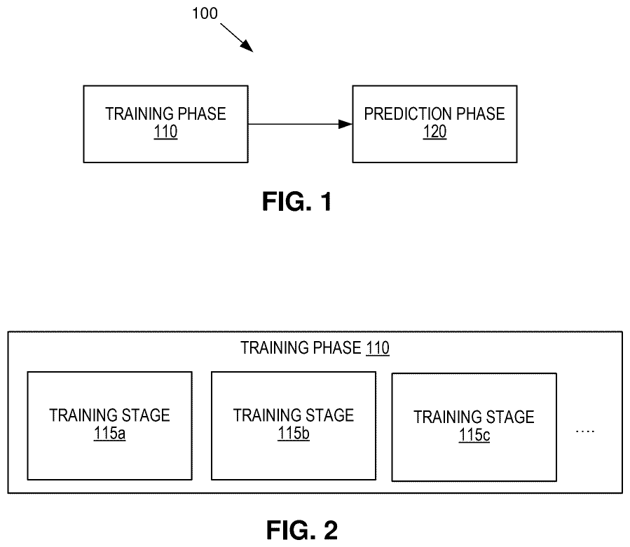

The embodiments described herein describe techniques that are based on AI models, each model focusing on the prediction of one or more metrics and/or features. FIG. 1 illustrates an example pipeline procedure 100 for predicting RF metrics. The pipeline procedure 100 comprises a training phase 110 in which AI models are trained using position information describing where real user measurements are geolocated. The pipeline procedure 100 further comprises a prediction phase 120 subsequent to the training phase 110. In the prediction phase 120, AI models derived from the training phase 110 are applied to predict one or more RF metrics (e.g., DL/UL user throughput, latency) in the areas where those RF metrics are unknown. For example, output from the prediction phase 120 may be used to fill in metrics that are missing from a database of metrics data storing metrics for each of a plurality of geographic locations.

The position information used as input may be expressed, for example, in terms of coordinates or other identifier of a unit of area. In one such example, each unit of a grid overlaid upon a geographic map may be uniquely identifiable. The area unit used may be of any size, depending on the embodiment (e.g., 20 square meters). In some contexts, the area units may be referred to as “pixels.” However, it should be noted that, in this disclosure, the term “pixel” does not refer to any unit within a display or image. Rather, the term “pixel” as used in this disclosure refers to a unit of geographic area.

The training phase 110 may comprise a plurality of training stages 115, e.g., as shown in the example illustrated in FIG. 2. In this example, the training phase 110 comprises a first training stage 115a, a second training stage 115b, and a third training stage 115c. Other embodiments may have additional, fewer, and/or different training stages 115. In each training stage 115, one or more metrics models are generated through AI training. For example, as will be discussed further below, the first training stage 115a may be an RF model training stage, the second training stage 115b may be a SINR training stage, and the third training stage 115c may be a throughput and latency training stage.

More specifically, the first training stage 115a may generate models for RF metrics, such as RSRQ, CQI, and/or RSSNR. The second training stage 115b may generate models for metrics such as PDSCH SINR and/or Physical Uplink Shared Channel (PUSCH) SINR. The third training stage 115c may generate models for DL user throughput, UL user throughput, and/or latency. In some embodiments, each of the training stages 115 is independent of the others and, therefore, can be executed in parallel. Once the AI models have been derived, they may then be used in to predict their respective RF metrics for use in the subsequent prediction phase 120.

As will be explained in more detail below, the training phase 110 (e.g., at one or more of the training stages 115) and the prediction phase 120 may accept a variety of inputs, depending on the embodiment. These inputs may include geolocated RF measurements, geolocated peak DL/UL user throughput and latency, cell configuration information, cell performance statistics, and/or User Equipment (UE) metrics.

Examples of geolocated RF measurements may include RSRP, RSRQ, CQI, RSSNR and PDSCH SINR that have been measured, e.g., at a particular location and at a particular time. In some embodiments, such measurements may include the time in which the measurements were taken, e.g., so that the measurements may be correlated in time and/or location with other metrics. For example, a CQI, RSRQ, RSSNR, and/or PDSCH SINR measurements may be correlated with a load factor included in certain cell performance statistics discussed below. That is, the predictions made by the pipeline procedure 100 may be based on inputs that are from the same time period.

For RSRP measurements, embodiments may obtain the signal strength levels of not only the serving cell, but also one or more neighbors (e.g., one or more neighbors that are closest to the serving cell and/or that have the strongest signals relative to other neighbors). The RSRP from the serving cell and one or more neighbors can be obtained from real measurements if they are available in the input data source (e.g., from a Minimization of Drive Test (MDT)) or from an external RSRP prediction tool.

Although certain measurements (e.g., RSRP) may be obtained for a plurality of cells, other measurements may be obtained for the serving cell only. These measurements may be represented by real user samples at the position where the measurement was taken.

Like RF measurements, geolocated peak DL/UL user throughput and latency measurements may be obtained from real user samples. In the case of throughput samples, the measurement should preferably be taken from a real data call with enough payload to fill the data buffer to its maximum level and reach the peak DL/UL user throughput. This information may come from speed tests (e.g., Ookla crowdsourcing), drive tests, or any tool able to measure achievable DL/UL user throughput. Particular embodiments of the present disclosure are intended to predict achievable DL/UL User Throughput, i.e., the DL/UL throughput that a user could reach with a given spectral efficiency and making use of resources not allocated to other users. Latency should preferably be measured from the same throughput tests, as they would generally be related to the same application server used for such tests.

Cell configuration information may include any one or more relevant configuration attributes of a cell, including (for example) the coordinates, azimuth, height, antenna gain, transmission power, Reference Signal (RS) power boosting, number of transmission antennas, frequency channel(s) (e.g., Absolute Radio Frequency Channel Number (ARFCN)), bandwidth, scheduling strategy, Physical Downlink Control Channel (PDCCH) number or Control Format Indicator (CFI), and/or radio model of the cell.

Cell performance statistics may include information counted, captured, or measured by an OSS or any higher-level abstraction thereof that reflects the performance of a cell in a given time period. Particular examples of cell performance statistics include DL/UL Physical Resource Block (PRB) utilization, DL cell load percentage, cell rank distribution, DL/UL cell modulation distributions, number of active UEs, number of connection setups, number of DL/UL scheduling entities, and average DL UE latency.

UE Metrics may include, for example, one or more indicators provided from the perspective of one or more UEs in a given time period. Particular examples of UE metrics include UE power headroom, UE PUSCH SINR, UE Category, and UE Model.

From such inputs, embodiments calculate a set of features for each cell-pixel pair within a specified area of interest of the cell. To do so, geolocated information may be aggregated at pixel level. As noted above, a pixel as used in this disclosure relates to a defined area of a certain resolution (e.g., 20×20 meters). In general, the number of samples in each pixel tends to impact the accuracy of the final predictions.

To visualize the statistical relevance of the used data, a report describing the number of geolocated samples and the number of samples per pixel may be created as an output of the pipeline procedure 100.

The calculated features feed a machine learning model, first to train the model with pixels where a given label (i.e., RSRQ, CQI, RSSNR, SINR, DL/UL User Throughput and Latency) is known, and then to predict the label in pixels where it is unknown.

As noted above, in particular embodiments, different AI models are executed sequentially. Some of these models may share the same features as others. That said, one or more models may have its own particularities.

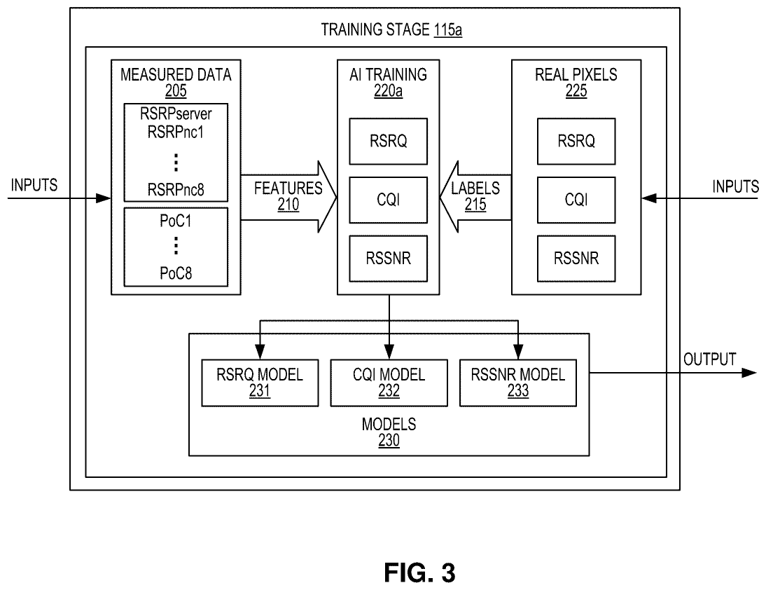

FIG. 3 illustrates an example of the first training stage 115a in greater detail. In this example, AI training 220a is performed to generate an RSRQ model 231, a CQI model 232, and an RSSNR model 233. This AI training 220a process is based on features 210 and labels 215 as inputs. In general, features 210 are data points that have been measured, whereas labels 215 relate to data points for which the pipeline procedure 100 makes predictions using one or more of the models 230. In this example, the AI training 220a uses the signal strength of a UE's serving cell (RSRP serving) as well as an array of signal strengths measured by the UE from the best neighbors having the same frequency channel as the serving cell (RSRPₙ₁−RSRPₙ₈, in this example).

The AI training 220a also uses an array representing the Probability of Collision (POC) between the serving cell and each neighbor cell (PoCₙ₁−PoCₙ₈, in this example) for real-world pixels 225. That is, the PoCₙ₁ represents the probability of a PRB from the serving cell being used at the same time as neighbor cell n1 at the same frequency channel. The PoC may, for example, be determined using equation 1, below:

$$PoC = \frac{Neighbor Load ( \% )}{100} \cdot \frac{Neighbor Bandwidth ( MHz ) ⋂ Serving Bandwidth ( MHz )}{Serving Bandwidth ( MHz )}$$

Once the AI models 230 are trained, each may be used to generate predictions. In this example, predictions of RSRQ, CQI, and RSSNR may be made using the RSRQ, CQI, and RSSNR models 231, 232, 233, respectively. As will be discussed below, these predictions may be used as input to the prediction phase 120.

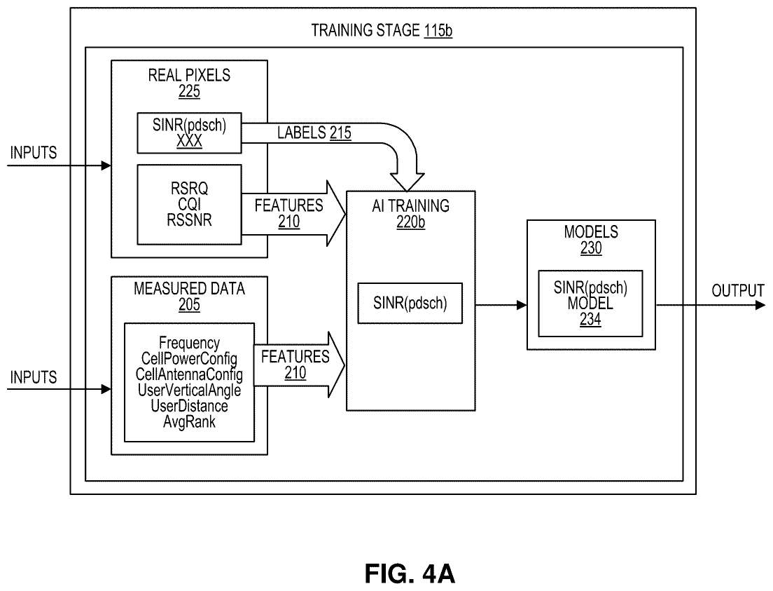

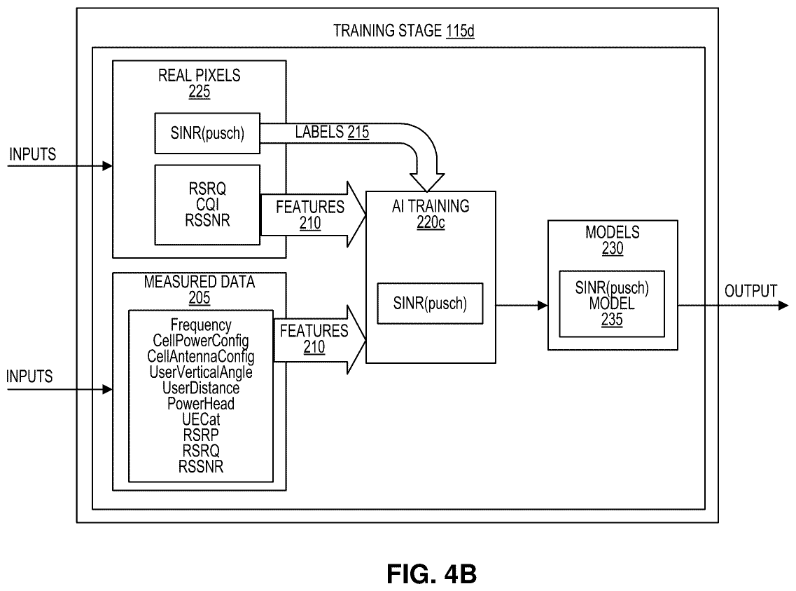

FIG. 4A illustrates an example of the second training stage 115b (in whole or in part). In the example of FIG. 4A, a model 234 for PDSCH SINR is generated through the use of AI training 220b. The AI training 220b that generates the PDSCH SINR model 234 uses PDSCH SINR labels 215 and a plurality of features 210. The features 210 may include RSRQ, CQI, and RSSNR, which may be associated with a particular pixel 225 of the area, for example. The features 210 may also include DL cell frequency channel, serving cell transmission power, RS power boosting, antenna gain, number of transmission antennas, pixel delta tilt, pixel distance (e.g., in meters between the pixel and the antenna), and/or rank utilization (e.g., the Multiple-Input Multiple Output (MIMO) rank distribution of the serving cell). Pixel delta may, for example, be calculated as the absolute difference between the antenna tilt (mechanical and electrical) and the impinging vertical angle of the pixel respect to the antenna. The models 230 may be used to provide output to the prediction phase 120.

Whereas FIG. 4A illustrates an example of a training stage 115b for generating a model 234 for DL SINR (specifically, PDSCH SINR), FIG. 4B illustrates a training stage 115d for generating a model for UL SINR (specifically PUSCH SINR). The example of FIG. 4B may be employed in additional or as an alternative to the example of FIG. 4A within the training stage 115b of various embodiments.

In the example of FIG. 4B, AI training 220c generates a PUSCH SINR model 235 using PUSCH SINR labels 215 and a plurality of features 210. The features 210 may include RSRQ, CQI, and RSSNR, which may be associated with a particular pixel 225 of the area, for example. The features 210 may also include DL cell frequency channel, number of transmission antennas, pixel delta tilt, pixel distance, power headroom, UE category, and/or UE model. The models 230 may be used to provide output to the prediction phase 120.

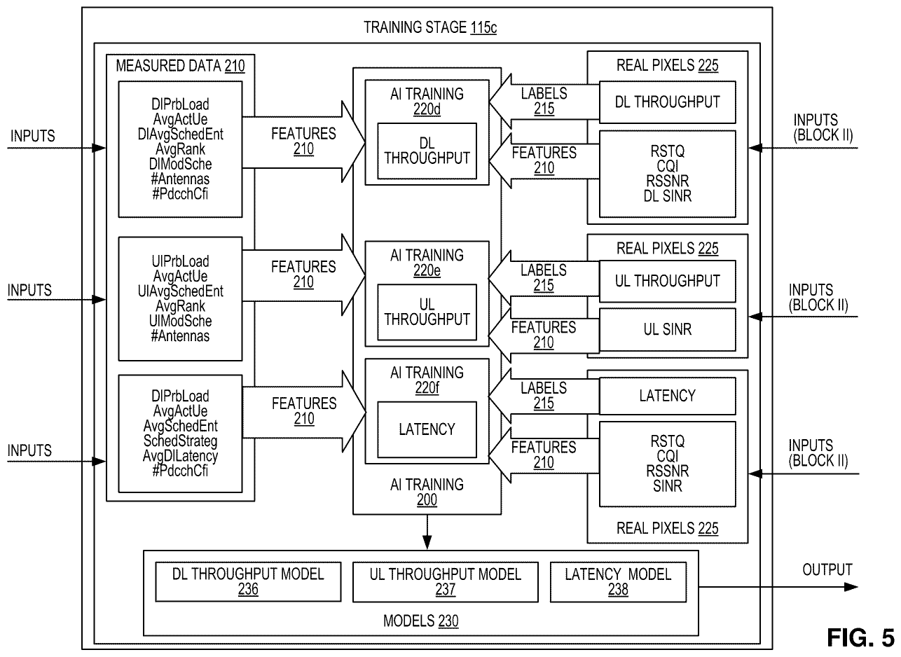

FIG. 5 illustrates an example of the third training stage 115c, according to some embodiments. In the example of FIG. 5, a DL throughput model 236, an UL throughput model 237, and a latency model 238 are generated through AI training 200. The AI training 200d-f that generates the models 236, 237, 238 use a plurality of labels 215 and features 210, including, e.g., DL SINR for the PDSCH from a serving cell, UL SINR for the PUSCH from a UE, RSRP, RSRQ, RSSNR, the number of PRBs left for user plane data in the cell, in the UL and/or DL, according to the available bandwidth (UL/DL PRB), the maximum number of PRB used for a given time period in the UL and/or DL (DL/UL Max PRB), the minimum number of PRB used for a given time period in the UL and/or DL (DL/UL Min PRB), the average DL/UL PRB used for a given time period, the average DL/UL scheduling entities used for a given time period, scheduling strategy, the average DL Cell Latency for a given time period, the average active UEs for a given time period, the DL/UL average modulation scheme for a given time period, rank utilization (e.g., MIMO rank distribution of a serving cell for a given time period), and/or number of TX antennas. The models 230 may be used to provide output to the prediction phase 120.

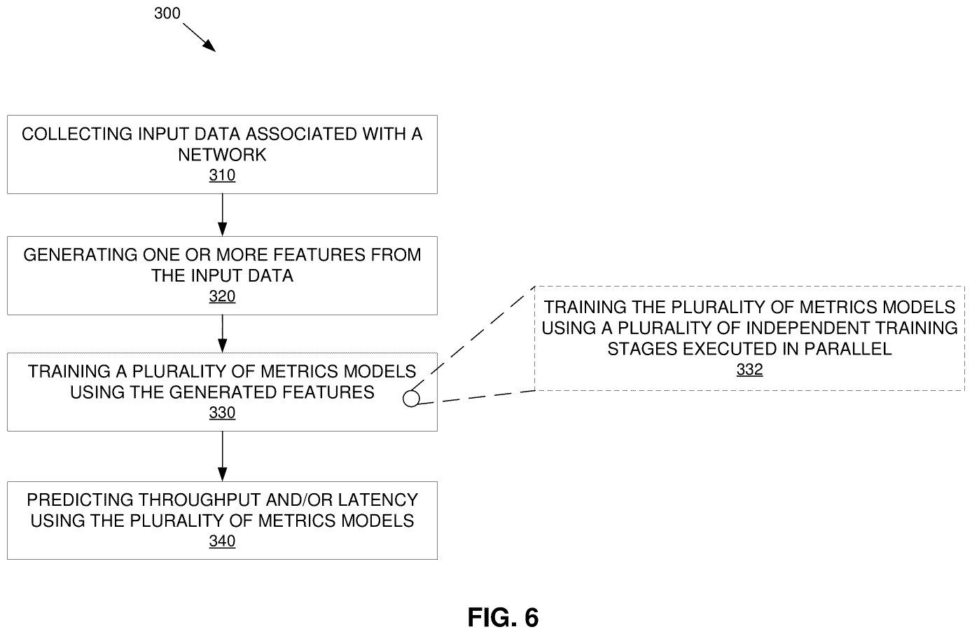

In view of the above, an example method 300 of predicting an RF metric in accordance with one or more embodiments of the present disclosure is illustrated in FIG. 6. The method 300 comprises collecting input data associated with a network (block 310). The method 300 further comprises generating one or more features 210 from the input data (block 320) and training a plurality of metrics models 230 using the generated features 210 (block 330). The method 300 further comprises predicting throughput and/or latency using the plurality of metrics models 230 (block 340).

As noted above, the training stages 115 may be independent of each other. Accordingly, training the plurality of metrics models may comprise training the plurality of metrics models 115 using a plurality of independent training states executed in parallel (block 332). In some embodiments, a first training stage 115a generates one or more AI models 230 trained to predict RF metrics (e.g., RSRQ, CQI, RSSNR). A second training stage 115b generates one or more AI models 230 trained to predict SINR (e.g., for the PDSCH). A third training stage 115c generates a plurality of AI models 230 trained to predict DL user throughput, UL user throughput, and latency, respectively.

In some embodiments, generating the models 230 may comprise using a Random Forest technique in which measurements of real data from the network are used to build a supervised system. Based on the provided known data, the Random Forest algorithm is used to learn how to predict the specific metric for every cell and pixel (i.e., location) combination. For example, a given training stage 115 may generate a plurality of decision trees, each of which represents a classification prediction with respect to the data. The decision tree that produces a classification prediction that best fits the data may be considered the prediction of the model 230.

Although Random Forest may be preferred in some embodiments, other embodiments may instead use other varieties of the Random Forest technique and/or other approaches entirely, e.g., in view of the trade-off between computational complexity and performance.

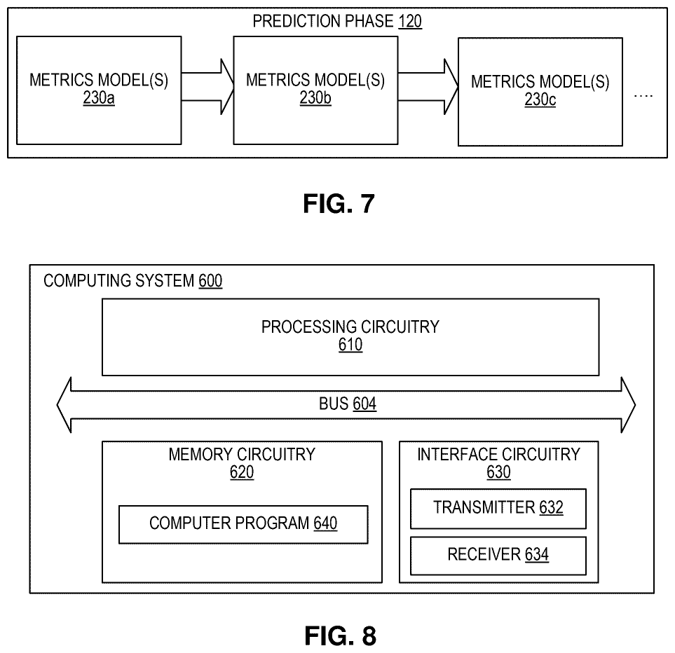

In the prediction phase 120, the trained models 230 from the training phase 110 may be used to predict different metrics in areas where such metrics are unknown. In this phase the generated models 230 may be dependent on each other. In one particular example, a plurality of metrics models 230a-c are sequentially pipelined to respect these dependencies, as shown in the example of FIG. 7. For example, based on the RSRP of a pixel and some known performance and configuration info from the cell, other metrics can be predicted. Although three sets of metrics models 230a-c are illustrated in FIG. 7, other embodiments may have additional, fewer, or different metrics model groupings and/or dependencies.

According to a particular example, a first set of one or more metrics models 230a in the pipeline are RSRQ, CQI, and RSSNR models. The output of these models 230a are used as inputs, along with performance and configuration inputs from other sources, to the second set of one or more metrics models 230b. The second set of metrics model(s) 230b is predicts the SINR of the PDSCH. The output of the second set of metrics model(s) 230b is used as an input to the third (and in this example, final) set of one or more metrics model(s) 230c in the pipeline. The third set of metrics model(s) 230c predicts DL user throughput, UL user throughput, and latency, e.g., based on the outputs from the previous sets of metrics models 230a, 230b.

Thus, embodiments disclosed herein provide a system in which a small group of real data from the network is used to build a sequence of AI models that can further predict additional metrics using a pipeline (or other dependency arrangement) of model predictions to construct further predictions across a plurality of different areas of the network, as may be needed or desired.

The processing described above may be performed by a centralized or distributed computing system of one or more computing devices. Such a computing system 600 may be implemented as schematically illustrated in the example of FIG. 8. The computing system 600 of FIG. 8 comprises processing circuitry 610, memory circuitry 620, and interface circuitry 630. The processing circuitry 610 is communicatively coupled to the memory circuitry 620 and the interface circuitry 630, e.g., via a bus 604. The processing circuitry 610 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 610 may be programmable hardware capable of executing software instructions stored, e.g., as a machine-readable computer program 640 in the memory circuitry 620. The memory circuitry 620 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 630 may comprise a controller configured to control data paths interconnecting components of the computing system 600 and/or connecting the computing device 600 to a network. The interface circuitry 630 may be implemented as a unitary physical component, or as a plurality of physical components that are contiguously or separately arranged, any of which may be communicatively coupled to any other or may communicate with any other via the processing circuitry 610. For example, the interface circuitry 630 may comprise a transmitter 632 configured to send wireless communication signals and a receiver 634 configured to receive wireless communication signals.

According to particular embodiments, the processing circuitry 610 is configured to collect input data associated with a network (e.g., via the interface circuitry 630). The processing circuitry 610 is further configured to generate one or more features from the input data, and train a plurality of metrics models 230 to predict respective metrics. The processing circuitry 610 is further configured to predict the respective metrics using the plurality of metrics models 230.

Still other embodiments include a control program 640 comprising instructions that, when executed on processing circuitry 610 of a computing system 600, cause the computing system 600 to carry out the method 300 described above.

Yet other embodiments include a carrier containing the control program 640. The carrier may be one of an electronic signal, optical signal, radio signal, or computer readable storage medium.

Although the computing system may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry that processes information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, the devices described herein may comprise multiple different physical components that make up a single illustrated component, and functionality may be partitioned between separate components.

1. A method, implemented by a computing system, the method comprising:
collecting input data associated with a network;
generating one or more features from the input data;
training a plurality of metrics models to predict respective metrics; and
predicting the respective metrics using the plurality of metrics models.

2. The method of claim 1, wherein training the plurality of metrics models comprises training the plurality of metrics models using a plurality of independent training stages executed in parallel.

3. The method of claim 1, wherein predicting the respective metrics comprises:
predicting a first set of metrics using a first set of the metrics models; and
predicting a second set of metrics using the first set of metrics as input to a second set of the metrics models.

4. The method of claim 3, wherein predicting the respective metrics further comprises predicting a third set of metrics using the second set of metrics as input to a third set of the metrics models.

5. The method of claim 4, wherein the first set of metrics comprises Reference Signal Received Quality, Channel Quality Indicator, or Reference Signal Signal-to-Noise Ratio.

6. The method of claim 4, wherein the second set of metrics comprises Signal-to-Interference Ratio (SINR).

7. The method of claim 4, wherein the third set of metrics comprises uplink user throughput, downlink user throughput, or latency.

8. The method of claim 1, wherein:
the collected input data comprises measured data obtained from a plurality of different locations spanning a geographic area;
the collected input data is missing metrics from one or more of the different locations; and
predicting the respective metrics using the plurality of metrics models comprises predicting the missing metrics for each of the one or more of the different locations.

9. A computing system, comprising:
processing circuitry and memory circuitry, the memory circuitry storing instructions executable by the processing circuitry whereby the computing system is configured to:
collect input data associated with a network;
generate one or more features from the input data;
train a plurality of metrics models to predict respective metrics; and
predict the respective metrics using the plurality of metrics models.

10. (canceled)

11. A non-transitory computer-readable medium storing thereon a computer program comprising instructions that, when executed on processing circuitry of a computing system, cause the computing system to carry out the method of claim 1.

12. (canceled)

13. The method of claim 4, wherein the first set of metrics comprises Reference Signal Received Quality.

14. The method of claim 4, wherein the first set of metrics comprises Channel Quality Indicator.

15. The method of claim 4, wherein the first set of metrics comprises Reference Signal Signal-to-Noise Ratio.

16. The method of claim 4, wherein the third set of metrics comprises uplink user throughput.

17. The method of claim 4, wherein the third set of metrics comprises downlink user throughput.

18. The method of claim 4, wherein the third set of metrics comprises latency.
